(19) United States
(12) Patent Application Publication
(10) Pub. No.: US 2005/0114114 A1
(43) Pub. Date: May 26, 2005

(54) System and method for providing a translational dictionary

(76) Inventor: Ariel Rudolph, Modi'in (IL)

Correspondence Address: Larry G. Brown;Motorola, Inc., Law Department, 8000 West Sunrise Boulevard, Fort Lauderdale, FL, 33322, US

(21) Appl. No.: 10/722,755

(22) Filed: Nov. 26, 2003

(51) Int. Cl. G06F 17/21

(52) U.S. Cl. 704/10

(57) ABSTRACT

The invention concerns a method (400, 500) of providing a translational dictionary. The method includes the steps of receiving (416, 516) at a communications device (114) a signal from a network (116), recognizing (418, 518) at least one target language from the receipt of the network signal, comparing (420, 520) the target language to a base language of the communications device and selectively transferring (434) to the communications device a translational dictionary of the target language if the target language does not match the base language. In one arrangement, if the target language does not match the base language, the method can also include the step of notifying (430) a user that the translational dictionary of the target language is available for transfer and giving (432) the user the option of accepting the transfer of the translational dictionary of the target language.

### CROSS REFERENCE TO RELATED APPLICATIONS

(Not Applicable)

### BACKGROUND

1. Technical Field

This invention relates in general to communications systems and more particularly, to the operation of such systems in different nations.

2. Description of the Related Art

The number of individuals traveling between countries, both business travelers and tourists, has steadily increased. In particular, business travel is more frequent in view of today's global economy. In many instances, there is a language barrier, a situation where the traveler does not speak or speaks very little of the host country's language(s). To overcome this obstacle, the traveler may be provided with an interpreter. This solution, however, can be expensive. Other travelers may purchase translation booklets, which typically provide a list of commonly used words in the user's native tongue along with corresponding entries in a foreign language. While helpful, travelers may find it inconvenient to carry around with them such a publication. Moreover, each time the traveler visits a new country with a different language, he or she must purchase a new translation booklet that includes references to the new country's language(s).

### SUMMARY OF THE INVENTION

The present invention concerns a method of providing a translational dictionary. The method includes the steps of receiving at a communications device a signal from a network, recognizing at least one target language from the receipt of the network signal, comparing the target language to a base language of the communications device and selectively transferring to the communications device a translational dictionary of the target language if the target language does not match the base language. The method can further include the steps of, if the target language does not match the base language, notifying a user that the translational dictionary of the target language is available for transfer and giving the user the option of accepting the transfer of the translational dictionary of the target language.

In one arrangement, the signal received from the network can include a Mobile Network Country Code. The recognizing step can further include recognizing the target language from the receipt of the Mobile Network Country Code in the network signal. The method can further include the step of storing into memory at least one value associated with the Mobile Network Country Code and at least one value associated with the base language. The values associated with the Mobile Network Country Code can identify target languages. In one arrangement, the target language can be a primary language that can be spoken in a first country, and the base language can be a primary language that can be spoken in a second country in which the network can be located in the first country.

The method can also include the step of signaling the network from the communications device that the target language does not match the base language. In addition, the selectively transferring step can further include selectively transferring to the communications device a translational dictionary of the target language unless the translational dictionary of the target language has been previously transferred to the communications device.

The present invention also concerns another method of providing a translational dictionary. This method includes the steps of storing at least one translational dictionary in a memory of a communications device, receiving at the communications device a signal from a network, recognizing at least one target language from the receipt of the network signal, comparing the target language to a base language of the communications device and accessing from the memory the translational dictionary if the target language does not match the base language and if the translational dictionary corresponds to the target language.

The present invention also concerns a communications device that provides a translational dictionary. The device includes a transceiver for receiving a signal from a network and a processor. The processor is programmed to recognize at least one target language from the receipt of the network signal and compare the target language to a base language of said communications device. The network selectively transfers to the communications device a translational dictionary of the target language if the processor determines that the target language does not match the base language. The system also includes suitable software and circuitry to carry out the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for providing a translation dictionary in accordance with the inventive arrangements;

FIG. 2 illustrates a communications device that can provide a translational dictionary in accordance with the inventive arrangements;

FIG. 3 illustrates an example of table that can be stored in the communications device of FIG. 2 in accordance with the inventive arrangements;

FIG. 4 illustrates a method of providing a translational dictionary in accordance with the inventive arrangements;

FIG. 5 illustrates another method of providing a translational dictionary in accordance with the inventive arrangements.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

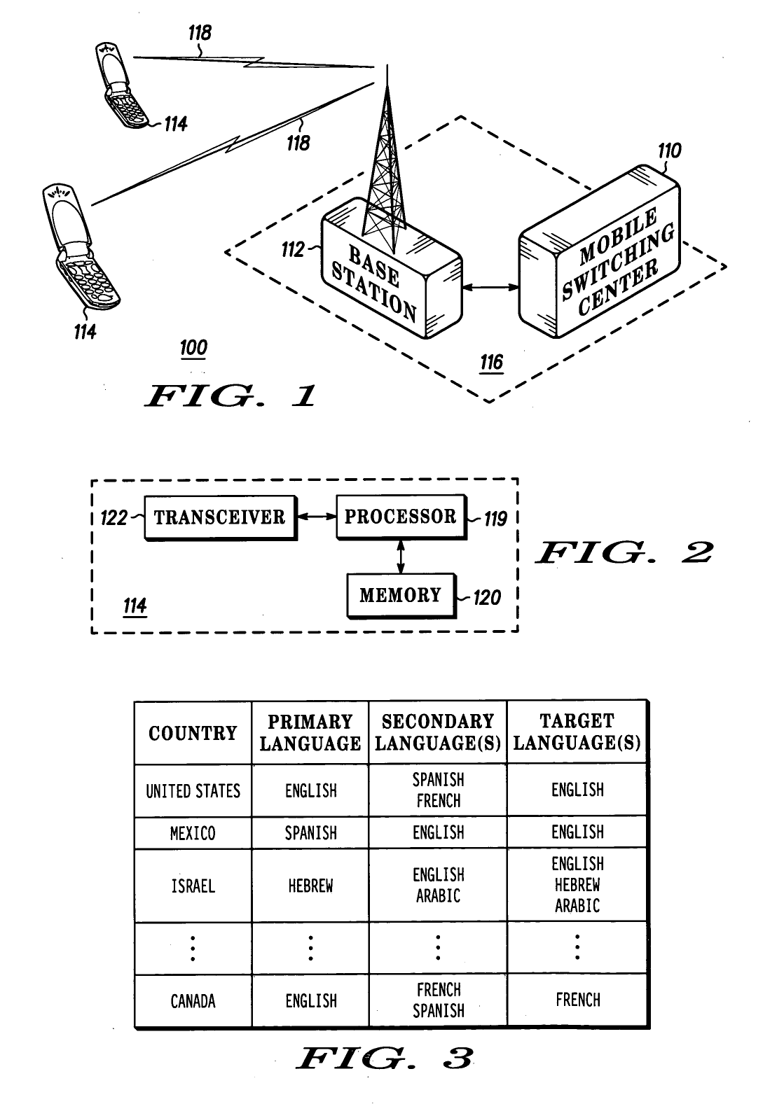

Referring to FIG. 1, a communications system 100 is shown. The system 100 can include, for example, at least one mobile switching center 110, at least one base station 112, which can be connected to the mobile switching center 110 through any suitable connection, and at least one communications device 114. The mobile switching center 110 and the base stations 112 can form a network 116, and the network 116 can be used to facilitate all suitable types of communications, including interconnect, i.e., full duplex, and dispatch, i.e., half-duplex, communications. The network 116 can contain any suitable number of mobile switching centers 110, base stations 112 and any other suitable type of equipment to enable it to provide communications services. The communications device 114 can wirelessly transmit to and receive from the network 116 communications signals over wireless communications links 118, and the communications device 114 can be any portable electronic unit for doing so, including a cellular telephone, a cellular telephone that supports half-duplex radio communications and a personal digital assistant. Other examples of a communications device are within contemplation of the inventive arrangements.

In one arrangement, the network 116 can be located in a first country, and the user of communications device 114 can be a resident of a second country. The communications device 114, as is understood by those of ordinary skill in the art, may synchronize itself and operate within the confines of the network 116 in the first country when the user of the communications device 114 from the second country visits the first country.

Any suitable number of languages may be spoken in both the first country and the second country. Many of these languages may be common to the first and second countries; in other cases, one or more of these languages may be different. Citizens of the first and second countries may conduct most of their conversations or written text in a dominant or primary language. For purposes of the invention, a primary language can be a language of a country in which the largest percentage (whether a majority or not) of that country's residents converse or write.

The primary language of the first country may differ from the primary language of the second country. As will be described below, a translational dictionary can be downloaded to the communications device 114 automatically or at the request of the user of the communications device 114. This translational dictionary can assist the user in translating the primary language of his or her country into the primary language of another country. It is understood, however, that the invention is not limited in this regard, as the translational dictionary can be used to translate any first language into any second language.

Referring to FIG. 2, an example of a communications device 114 is shown. The communications device 114 can include a processor 119, a memory 120 and a transceiver 122. As those of ordinary skill in the art will appreciate, the communications device 114 may also include any other suitable component to enable the communications device 114 to transmit and receive any suitable type of communications signal. Referring to FIGS. 1 and 2, as those of ordinary skill in the art will further appreciate, when the communications device 114 enters the network 116, the communications device 114 can synchronize with the network 116 to enable the communications device 114 to operate within the network 116.

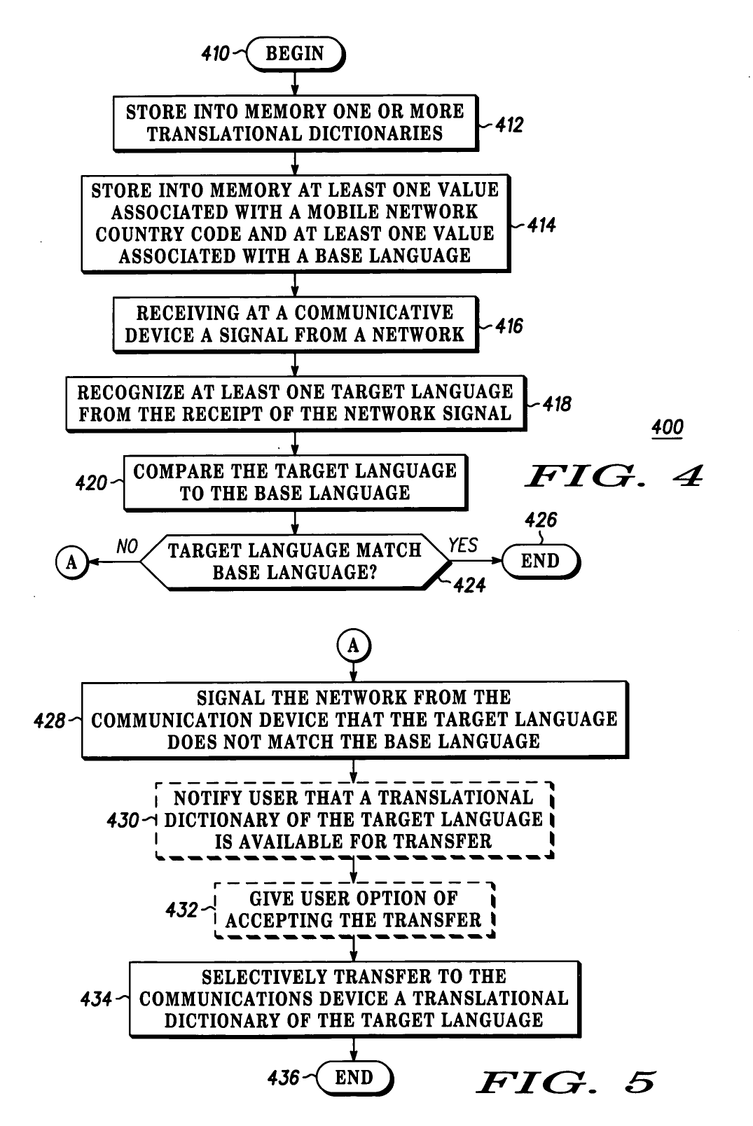

In one arrangement, one or more tables can be loaded and stored in the memory 120. An example of a table 124 that can be loaded and stored in the memory 120 is illustrated in FIG. 3. Here, the names of any suitable number of countries and any suitable number of the different languages spoken in each particular country can be values of the table 124. As an example, at least one of the languages can be designated as a primary language, and any remaining languages can be designated as secondary languages. In one arrangement, one or more other languages, regardless of whether they are listed as a primary or secondary language, can be designated as a target language. The target language can be the language that a user of the communications device 114 wishes to have translated into another language, such as the user's own language. This process will be described below.

As an example, referring to the first entry in the table 124, the United States can be listed as a value of the table 124, and languages spoken in the United States, such as English, Spanish or French, can be listed as primary and/or secondary languages. The target language can be listed as English as well. The target language can be selected by the user through a set of menus or can be a preprogrammed selection, which can be performed by the manufacturer or any other suitable entity. The target language(s) for a particular country can be selected from the primary or secondary languages (or a combination thereof) of that country. It is understood that more than one language can be designated as a target language. Moreover, the invention is not limited to the example described above or pictured in FIG. 3, as the table 124 can include any country and any other languages.

The network 116 (see FIG. 1) can contain any suitable type of a storage unit (not shown), such as a server, for storing translational dictionaries. The translational dictionaries can include words or symbols of a first language and the translations of those words or symbols in one or more second languages, i.e., the translational dictionary can include any suitable number of second languages. In one arrangement, the translational dictionaries can include words of the primary language or the secondary languages of the country in which the network 116 is situated and the translational entries of corresponding words of one or more different languages. As a more specific example, if the network 116 is located in the United States, the network 116 can store translational dictionaries that include word entries in English with corresponding translations of those words in Spanish, French or any other language. In an alternative arrangement, the translational dictionaries can be stored in the memory of a communications device, such as in the memory 120 of the communications device 114 of FIG. 2.

Referring again to FIG. 2, the communications device 114 can have a base language. As an example, the base language can be the language that is displayed the majority of the time on the display or other user interface of the communications device 114. The processor 119 can be aware of the base language.

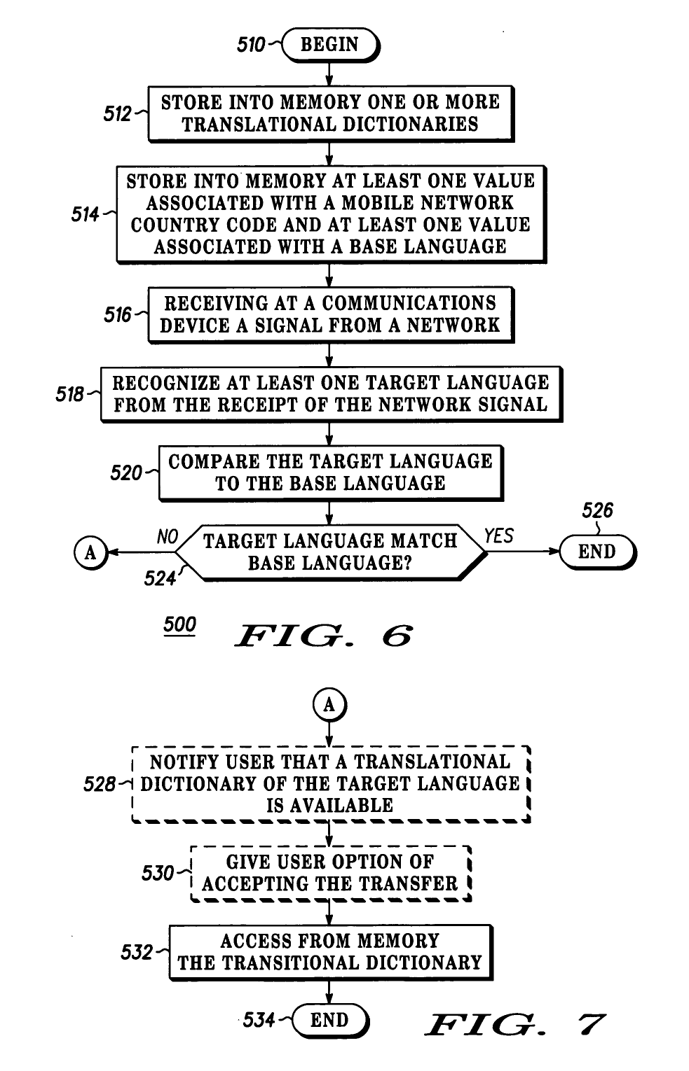

Referring to FIG. 4, a method 400 for providing a translational dictionary is shown. To explain the method 400, reference will be made to FIGS. 1-3, although it is understood that the invention is not limited to the configurations shown in those drawings, as the method 400 can be practiced in any suitable system. The method 400 can begin at step 410, and at step 412, one or more translational dictionaries can be stored into memory. As noted above, these translational dictionaries can be stored in a storage device of the network 116 (i.e., remotely stored relevant to a communications device served by the network 116) or the memory 120 of the communications device 114. Any suitable number of translational dictionaries can be stored, and these translational dictionaries can provide translation for any suitable number and type of languages.

At step 414, at least one value associated with a Mobile Network Country Code (MNCC) and at least one value associated with a base language can be stored into memory. As is known in the art, the MNCC comprises data that a communications device uses to synchronize with a network in a particular country. This synchronization can also permit the communications device to identify in which country the communications device is situated. One or more values can be, for example, stored in the memory 120 of the communications device 114 in which the value identifies the target language of the country associated with the MNCC. As an example and without limitation, the value can be the name of a country that has been recited in the table 124 (see FIG. 3), which provides the target languages for each country. Thus, once the processor 119 of the communications device 114 ascertains the country in which it is located, the processor 119 of the communications device 114 can determine the target language for that country. As explained above, the target language(s) for a particular country can be stored in the table 124 and can be preprogrammed or can be determined by a user. A value can also be stored in the memory 120 that identifies the base language of the communications device 114.

As shown at step 416, the communications device, such as communications device 114, can receive a signal from a network, such as the network 116. At step 418, at least one target language can be recognized from the receipt of the network signal. For example, when the communications device 114 synchronizes with the network 116, the processor 119 of the communications device 114 can determine in which country the network 116 is disposed by processing the MNCC. Based on this step, the processor 119 can access the stored value, e.g., the country name, from the table 124 of the memory 120 and can determine the relevant target languages.

At step 420, the target language can be compared to the base language. For example, the processor 119 can compare the stored value for the target language to the stored value for the base language. If they match, as determined at decision block 424, it is unnecessary to download a translational dictionary, and the method can end at step 426. The communications device 114 can signal the network 116 that no transfer is necessary. An example of this process is when a U.S. resident who uses a communications device in which the base language is English returns home from a trip overseas. It is understood, however, that the invention is not limited in this regard, as it can be configured to accept translational dictionaries if the base language does match the target language.

Referring back to the decision block 424, if the target language does not match the base language, then (through jump circle A) the communications device (such as communications device 114) can signal the network (such as network 116) that the target language does not match the base language, as shown at step 428. If more than one target language exists and at least one of them matches the base language, the method 400 can still proceed to step 428. The matching target language, however, can be ignored, as it is unnecessary to transfer it to the communications device.

As an option, the user can be notified that a translational dictionary of the target language is available for transfer, as shown at step 430. As another option, at step 432, the user can be given the choice of accepting the transfer of the translational dictionary. For example, the user can receive a message through a display of the communications device 114 that a translational dictionary that has translations of the user's base language to the target language(s) is available for transfer, and the user can be given the option of accepting this transfer by making a corresponding selection in a menu. If the user accepts the transfer, the translational dictionary of the target language can be transferred to the communications device, as shown at step 434. As an example, the translational dictionary can be transferred over a control channel to the communications device. Steps 430 and 432 are optional because the transfer of a translational dictionary may occur without any interaction on the user's part. For example, the network 116 can automatically transfer the translational dictionary to the communications device 114, and the user is not required to take any action.

If more than one target language exists, translational dictionaries can be automatically transferred for all or a fewer number of the target languages. Additionally, if more than one target is available, the user can be given the opportunity to select—through a menu—translational dictionaries for all or a fewer number of the target languages. In another arrangement, if a translational dictionary has previously been transferred to the communications device, then the transfer of that same translational dictionary is unnecessary. The process can end at step 436.

An example of this process will be illustrated. A user who is a U.S. citizen and who carries a communications device with a base language of English may visit Israel. Referring to the table 124 of FIG. 3, the target languages for Israel can be English, Hebrew and Arabic (Hebrew is listed as the primary language). Previously, the user may have selected these languages as target languages or the manufacturer or some other entity may have done so. When the user's communications device synchronizes with a network in Israel, the communications device, through the MNCC, can recognize that it is currently in that country. The communications device can compare these target languages to the base language and can determine that one of the target languages (English) matches the base language (English). The communications device can also determine that two of the target languages (Hebrew and Arabic) do not match the base language.

At this point, the communications device can signal the network, and the network can transfer one or more translational dictionaries to the communications device in which the translational dictionaries contain translations of words in English to Hebrew and Arabic. Of course, the user may be notified that these translational dictionaries are available for download, and the user can through a menu choose to download one or more of these translational dictionaries, if he or she wishes.

Referring to FIG. 5, another method 500 for providing a translational dictionary is shown. Steps 510-526 correspond to steps 410-426, and as a result, no explanation is warranted here. In this method 500, however, the translational dictionaries can be stored in the memory of the communications device, such as the memory 120 of the communications device 114. Once it has been determined that the base language does not match the target language(s) (see step 524), similar to corresponding step 430 of method 400, the user can be optionally notified that one or more translational dictionaries of the target language(s) are available for him to access, as shown at step 528. At option step 530, the user can be given the choice of accessing one or more of the translational dictionaries. At step 532, the translational dictionary can be accessed from memory, such as the memory 120 of the communications device 114. The method 500 can end at step 534.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method of providing a translational dictionary, comprising the steps of:
receiving at a communications device a signal from a network;
recognizing at least one target language from the receipt of the network signal;
comparing the target language to a base language of the communications device;
selectively transferring to the communications device a translational dictionary of the target language if the target language does not match the base language.

2. The method according to claim 1, further comprising the steps of:
if the target language does not match the base language, notifying a user that the translational dictionary of the target language is available for transfer; and
giving the user the option of accepting the transfer of the translational dictionary of the target language.

3. The method according to claim 1, wherein the signal received from the network includes a Mobile Network Country Code and wherein said recognizing step further comprises recognizing the target language from the receipt of the Mobile Network Country Code in the network signal.

4. The method according to claim 3, further comprising the step of storing into memory at least one value associated with the Mobile Network Country Code and at least one value associated with the base language, wherein the values associated with the Mobile Network Country Code identify target languages.

5. The method according to claim 1, wherein the target language is a primary language that is spoken in a first country and the base language is a primary language that is spoken in a second country, wherein the network is located in the first country.

6. The method according to claim 1, further comprising the step of signaling the network from the communications device that the target language does not match the base language.

7. The method according to claim 1, wherein said selectively transferring step further comprises selectively transferring to the communications device a translational dictionary of the target language unless the translational dictionary of the target language has been previously transferred to the communications device.

8. A method of providing a translational dictionary, comprising the steps of:
storing at least one translational dictionary in a memory of a communications device;
receiving at the communications device a signal from a network;
recognizing at least one target language from the receipt of the network signal;
comparing the target language to a base language of the communications device; and
accessing from the memory the translational dictionary if the target language does not match the base language and if the translational dictionary corresponds to the target language.

9. A communications device that provides a translational dictionary, comprising:
a transceiver for receiving a signal from a network; and
a processor, wherein said processor is programmed to:
recognize at least one target language from the receipt of the network signal; and
compare the target language to a base language of said communications device;
wherein the network selectively transfers to said communications device a translational dictionary of the target language if said processor determines that the target language does not match the base language.

10. The communications device according to claim 9, wherein if the target language does not match the base language, said processor is further programmed to notify a user through a user interface that the translational dictionary of the target language is available for transfer and to give the user through a menu the option of accepting the transfer of the translational dictionary of the target language.

11. The communications device according to claim 9, wherein the signal received from the network includes a Mobile Network Country Code and wherein said processor is further programmed to recognize the target language from the receipt of the Mobile Network Country Code in the network signal.

12. The communications device according to claim 11, further comprising a memory, wherein at least one value associated with the Mobile Network Country Code and at least one value associated with the base language are stored in said memory, wherein the values associated with the Mobile Network Country Code identify target languages.

13. The communications device according to claim 9, wherein the target language is a primary language that is spoken in a first country and the base language is a primary language that is spoken in a second country, wherein the network is located in the first country.

14. The communications device according to claim 9, wherein said processor is further programmed to signal the network through said transceiver that the target language does not match the base language.

15. The communications device according to claim 9, wherein the network selectively transfers to said communications device the translational dictionary unless the network has previously transferred the translational dictionary to said communications device

16. A communications device for providing a translational dictionary, comprising:
a memory for storing at least one translational dictionary;
a transceiver for receiving a signal from a network; and
a processor, wherein said processor is programmed to:
recognize at least one target language from the receipt of the network signal;
compare the target language to a base language of said communications device; and
access from said memory the translational dictionary if the target language does not match the base language and if the translational dictionary corresponds to the target language.
